(19) United States
(12) Patent Application Publication
(10) Pub. No.: US 2022/0344748 A1
(43) Pub. Date: Oct. 27, 2022

(54) CAR POWER SUPPLY SYSTEM AND SOLID OXIDE FUEL CELL VEHICLE

(71) Applicant: Ceres Intellectual Property Company Limited, Horsham West Sussex (GB)

(72) Inventors: Xiaowen Sun, Weifang, Shandong (CN); Yanbo Wang, Weifang, Shandong (CN); Youpeng Chen, Weifang, Shandong (CN); Changming Hu, Weifang, Shandong (CN); Jin-Li Pei, Weifang, Shandong (CN); Lei Sun, Weifang, Shandong (CN); Yaxin Du, Weifang, Shandong (CN)

(21) Appl. No.: 17/763,539

(22) PCT Filed: Sep. 25, 2020
(86) PCT No.: PCT/IB2020/059005

§ 371 Date: Mar. 24, 2022

(30) Foreign Application Priority Data
Sep. 26, 2019 (CN) 201921621667.8

(51) Int. Cl. H01M 16/00; H01M 10/052; H01M 8/04955; B60L 58/30; B60L 50/75; H01M 8/04303

(52) U.S. Cl. CPC H01M 16/006; H01M 10/052; H01M 8/04955; B60L 58/30; B60L 50/75; H01M 8/04303; H01M 2008/1293

(57) ABSTRACT

The present application discloses a car power supply system and a solid oxide fuel cell vehicle. The car power supply system specifically comprises a first battery, a vehicle control unit (VCU), a lithium battery management system, a solid oxide fuel cell control unit, a second battery, a first relay and a second relay. If a solid oxide fuel cell controlled by the solid oxide fuel cell control unit provided by the present application cannot stop working within a short time, the first relay restores the first battery to power the VCU and the lithium battery management system after a start switch stops power supply by the first battery, so that the solid oxide fuel cell control unit is powered by the second battery to make the cell work normally and realize power off, thereby preventing the problem that the solid oxide fuel cell cannot work due to rapid power failure of the vehicle.

### TECHNICAL FIELD

The present invention relates to the technical field of new energy, particularly to a car power supply system and a solid oxide fuel cell vehicle.

### BACKGROUND ART

Solid oxide fuel cells have been increasingly used due to their excellent characteristics and have been developed together with hydrogen fuel cells in the field of vehicle power. When the solid oxide fuel cell is loaded and used, it can be powered off only for a longer time relative to other equipment on the vehicle due to its operating characteristics, and needs to be supported by external power at the time of powering off. If the external power is lost during this period, the solid oxide fuel cell cannot work normally.

### SUMMARY OF THE INVENTION

In view of this, the present invention provides a car power supply system and a solid oxide fuel cell vehicle. The car power supply system is used for ensuring the power supply of a solid oxide fuel cell when the vehicle powers down, thereby preventing its failure to work normally due to rapid power failure of the vehicle.

A first aspect of the invention provides a car power supply system applied to a solid oxide fuel cell vehicle, wherein the car power supply system comprises a first battery, a vehicle control unit (VCU), a lithium battery management system, a solid oxide fuel cell control unit, a second battery, a first relay and a second relay, wherein:

an electrical output end of the first battery is electrically connected to an electrical receiving end of the VCU and an electrical receiving end of the lithium battery management system, respectively;

the first relay is arranged on a first conductor which is connected between the electrical output end of the first battery and the electrical receiving end of the VCU, connected in parallel to a start switch of the solid oxide fuel cell vehicle, and configured to conduct the first conductor when receiving a first switch-on signal;

a signal output end of the VCU is connected to a control signal receiving end of the second relay, and configured to output a second switch-on signal when the electrical receiving end of the VCU is powered on and to output a second switch-off signal when the electrical receiving end of the VCU is powered off;

an electrical output end of the second battery is electrically connected to the electrical receiving end of the solid oxide fuel cell control unit through a second conductor;

the second relay is arranged on the second conductor, and configured to conduct the second conductor when receiving the second switch-on signal and to turn off the second conductor when receiving the second switch-off signal; and

a signal output end of the solid oxide fuel cell control unit is connected to a control signal receiving end of the first relay, and configured to output the first switch-on signal when the solid oxide fuel cell of the solid oxide fuel cell vehicle cannot be powered off within a short time.

The first battery can be a lead-acid battery for the solid oxide fuel cell vehicle.

The second battery can be a lithium battery in a signal connection with the lithium battery management system.

A second aspect of the invention provides a solid oxide fuel cell vehicle, wherein the solid oxide fuel cell vehicle is provided with the car power supply system according to the first aspect.

The present application discloses a car power supply system and a solid oxide fuel cell vehicle. The car power supply system comprises a first battery, a vehicle control unit (VCU), a lithium battery management system, a solid oxide fuel cell control unit, a second battery, a first relay and a second relay. If a solid oxide fuel cell controlled by the solid oxide fuel cell control unit provided by the present application cannot stop working within a short time, the first relay restores the first battery to power the VCU and the lithium battery management system after a start switch stops power supply by the first battery, so that the solid oxide fuel cell control unit is powered by the second battery to make the cell work normally and realize power off, thereby preventing the problem that the solid oxide fuel cell cannot work due to rapid power failure of the vehicle.

### BRIEF DESCRIPTION OF THE DRAWINGS

The drawings used in the description will be briefly described below. The drawings in the description below are just some embodiments of the present application.

FIG. 1 is a structural diagram of a car power supply system.

### DETAILED DESCRIPTION

Embodiments of the present invention will described below in conjunction with the drawings in the embodiments of the present application. The described embodiments are only some, not all of the embodiments of the present application.

### Embodiment I

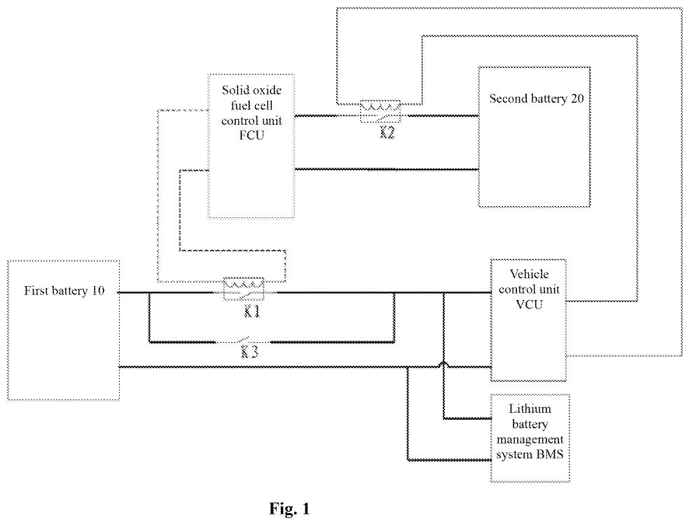

FIG. 1 is a structural diagram of a car power supply system in an embodiment of the present application. As shown in FIG. 1, the car power supply system provided by this embodiment is applied to a solid oxide fuel cell vehicle. The solid oxide fuel cell vehicle here refers to vehicles or other means of transportation taking the solid oxide fuel cell as a main power. The car power supply system comprises a first battery 10, a vehicle control unit VCU, a lithium battery management system BMS, a solid oxide fuel cell control unit FCU, a second battery 20, a first relay K1 and a second relay K2.

The first battery is a lead-acid battery for the solid oxide fuel cell vehicle, and has an electrical output end electrically connected to an electrical receiving end of the VCU and an electrical receiving end of the lithium battery management system through conductors. A corresponding loop is formed through the corresponding conductors at the time of connecting. For instance, a positive electrode of the electrical output end is connected to a positive electrode of the corresponding electrical receiving end, and a negative electrode of the electrical output end is connected to the negative electrode of the corresponding electrical receiving end. The conductor, used for connecting the positive electrode of the electrical output end to the positive electrode of the electrical receiving end of the VCU, is called the first conductor.

The first conductor is provided with the first relay; the first conductor conducts when the first relay conducts, and on the contrary, the first conductor cuts off. The first relay is connected in parallel to a start switch K3 of a vehicle; the vehicle starts when the start switch is started, and at this time, the VCU and the lithium battery management system are powered on to work. The lithium battery management system also drives the second battery to start working, and the second battery here is the lithium battery.

The second battery, i.e., the lithium battery, is electrically connected to the solid oxide fuel cell control unit used for controlling the solid oxide fuel cell of the vehicle, so as to power the control unit. Only the control unit receiving the power supply can normally control the solid oxide fuel cell to work normally.

An electrical output end of the second battery is connected to the electrical receiving end of the solid oxide fuel cell control unit, specifically, a positive electrode of an electrical output end of the second battery is electrically connected to a positive electrode of an electrical receiving end of the solid oxide fuel cell through the second conductor, a negative electrode of the electrical output end of the second battery is electrically connected to a negative electrode of the electrical receiving end of the solid oxide fuel cell, thereby forming a power supply loop.

The second relay is arranged on the second conductor to conduct or cut off the power supply for the solid oxide fuel cell by the second conductor. The vehicle is controlled after the VCU is powered on, and besides, a signal output end thereof is connected to a control signal input end of the second relay. The VCU outputs a second switch-on signal to the second relay after being powered, and outputs a second switch-off signal to the second relay after being powered off. The second relay conducts the second conductor after receiving the second switch-on signal, so that the solid oxide fuel cell is powered to work. Conversely, the second switch-off signal cuts off the second relay to power off the solid oxide fuel cell due to power loss.

One signal output end of the solid oxide fuel cell control unit is connected to a control signal output end of the first relay. When the start switch is turned off, the signal output end outputs a first switch-on signal to the first relay when the solid oxide fuel cell controlled by the solid oxide fuel cell control unit cannot be powered off within a short time.

The first switch-on signal is used for controlling the first relay to conduct the first conductor, so that the VCU and the lithium battery management system start working again; the lithium battery management system controls the second battery to output electric energy, the VCU outputs a second switch-on signal to the second relay, and the second switch-on signal controls the second conductor to be conducted, so that the solid oxide fuel cell control unit is powered by the re-output electric energy through the second conductor, and the solid oxide fuel cell control unit can normally control the solid oxide fuel cell to work normally and realize power off.

The operations that the VCU outputs the second switch-on signal and the second switch-off signal, and the solid oxide fuel cell control unit outputs the first switch-on signal, do not rely on a computer program, but are the functions of the VCU and the solid oxide fuel cell control unit themselves.

This embodiment provides a car power supply system. The car power supply system, applied to the solid oxide fuel cell vehicle, comprises the first battery, the VCU, the lithium battery management system, the solid oxide fuel cell control unit, the second battery, the first relay and the second relay. If a solid oxide fuel cell controlled by the solid oxide fuel cell control unit provided by the present application cannot stop working within a short time, the first relay restores the first battery to power the VCU and the lithium battery management system after a start switch stops power supply by the first battery, so that the solid oxide fuel cell control unit is powered by the second battery to make the cell work normally and realize power off, thereby preventing the problem that the solid oxide fuel cell cannot work due to rapid power failure of the vehicle.

### Embodiment II

This embodiment provides a solid oxide fuel cell vehicle, wherein the vehicle is provided with a car power supply system provided in the previous embodiment.

This embodiment provides a car power supply system. The car power supply system, applied to a solid oxide fuel cell vehicle, specifically comprises a first battery, a vehicle control unit (VCU), a lithium battery management system, a solid oxide fuel cell control unit, a second battery, a first relay and a second relay.

If a solid oxide fuel cell controlled by the solid oxide fuel cell control unit provided by the present application cannot stop working within a short time, the first relay restores the first battery to power the VCU and the lithium battery management system after a start switch stops power supply by the first battery, so that the solid oxide fuel cell control unit is powered by the second battery to make the cell work normally and realize power off, thereby preventing the problem that the solid oxide fuel cell cannot work due to rapid power failure of the vehicle.

The embodiments in the description are described in a progressive manner and the same or similar parts among the embodiments can be mutually referred to, and each embodiment focuses on the differences from other embodiments.

Although the embodiments of the present invention have been described, other changes and modifications could be made to these embodiments. Accordingly, the claims cover the embodiments and all the changes and modifications falling into the scope of the present invention.

Relational terms such as “first” and “second” and the like may be used solely to distinguish one entity or action from another entity or action without necessarily requiring or implying any such actual relationship or order between such entities or actions.

The technical solutions provided by the present invention are elaborated above. Specific embodiments are disclosed to set forth the principle and method of implementation of the present invention, and the foregoing illustration of the above embodiments is only used to assist in understanding the methods and core concepts of the present invention. The contents of the description should not be understood as limitations on the scope of the present invention.

1. A car power supply system applied to a solid oxide fuel cell vehicle, comprising:
a first battery,
a vehicle control unit (VCU),
a lithium battery management system,
a solid oxide fuel cell control unit,
a second battery,
a first relay, and
a second relay,
wherein
an electrical output end of the first battery is electrically connected to an electrical receiving end of the VCU and an electrical receiving end of the lithium battery management system, respectively;
the first relay is arranged on a first conductor which is connected between the electrical output end of the first battery and the electrical receiving end of the VCU, connected in parallel to a start switch of the solid oxide fuel cell vehicle, and configured to conduct the first conductor when receiving a first switch-on signal;
a signal output end of the VCU is connected to a control signal receiving end of the second relay, and configured to output a second switch-on signal when the electrical receiving end of the VCU is powered on and to output a second switch-off signal when the electrical receiving end of the VCU is powered off;
an electrical output end of the second battery is electrically connected to the electrical receiving end of the solid oxide fuel cell control unit through a second conductor;
the second relay is arranged on the second conductor, and configured to conduct the second conductor when receiving the second switch-on signal and to turn off the second conductor when receiving the second switch-off signal; and
a signal output end of the solid oxide fuel cell control unit is connected to a control signal receiving end of the first relay, and configured to output the first switch-on signal when the solid oxide fuel cell of the solid oxide fuel cell vehicle cannot be powered off within a short time.

2. The car power supply system according to claim 1, wherein the first battery is a lead-acid battery for the solid oxide fuel cell vehicle.

3. The car power supply system according to claim 1, wherein the second battery is a lithium battery in a signal connection with the lithium battery management system.

4. A solid oxide fuel cell vehicle, comprising the car power supply system according to claim 1.
